(19) United States
(12) Patent Application Publication
(10) Pub. No.: US 2022/0375132 A1
(43) Pub. Date: Nov. 24, 2022

(54) PLANAR IMAGE COMPRESSION

(71) Applicant: HEWLETT-PACKARD DEVELOPMENT COMPANY, L.P., Spring, TX (US)

(72) Inventors: Lluis ABELLO ROSELLO, Sant Cugat del Valles (ES); Pau COSTAL FORNELLS, Sant Cugat del Valles (ES); Carlos FAJARDO SANCHEZ, Sant Cugat del Valles (ES)

(21) Appl. No.: 17/772,056

(22) PCT Filed: Dec. 3, 2019
(86) PCT No.: PCT/US2019/064265

§ 371 Date: Apr. 26, 2022

(51) Int. Cl. G06T 9/00; G06T 3/40

(52) U.S. Cl. CPC G06T 9/00; G06T 3/4007

(57) ABSTRACT

Examples relate to image processing, and performing fixed length format cell compression on a cell of a planar colour image based on an amount of white colour of the cell, the cell comprising a plurality of pixels, to obtain a compressed cell having four or fewer colour levels; and performing variable length format cell compression on the compressed cell to obtain a coded compressed cell.

### BACKGROUND

Compression of continuous tone images may be used in printing workflows to reduce the storage and bandwidth requirements to transfer rasterized pages before they are processed by the printer pipeline. Images sent to the printer by the driver or external raster image processor may be compressed to reduce the transmission time. Print jobs and pages stored to disk for queuing and re-printing may also be compressed to reduce read/write time and storage. Compression of images may affect image quality. For example, edges in images may lose definition following compression.

### BRIEF INTRODUCTION OF THE DRAWINGS

Examples implementations are described below with reference to the accompanying drawings, in which:

FIGS. 1a-1c show example printed images compressed in different ways;

FIGS. 2a-2c illustrate example printed images compressed in different ways;

FIG. 3 depicts a method according to an example;

FIGS. 4a and 4b illustrate example methods;

FIG. 5 shows example common masks;

FIG. 6 illustrates an example apparatus according to an example; and

FIG. 7 shows machine readable storage and machine executable instructions according to an example.

### DETAILED DESCRIPTION

Lossless compression algorithms preserve the exact content, but do not guarantee any compression, and yield very poor compression ratios when compressing photographs. Lossy compression algorithms may provide a reduction in computational resource requirements compared with lossless algorithms, but do not guarantee maintaining a high quality of output image. For example, an output image may include unwanted blurred, jagged, or pixelated edges. Definition of edges in an output image may be lost, for example by a white portion of the image appearing fuzzy or containing unwanted non-white pixels.

It may be desirable to improve print quality compared with other compression methods. Examples disclosed herein may provide an improvement in image quality compared to lossy compression methods, while allowing for a reduction in computation resources required to process the image compared with lossless compression methods. That is, certain examples may provide an improvement in output image quality over other compression methods while using a reasonable amount of computation (that is, using reduced computational requirements compared with non-compressed images, which are manageable and workable in practice). Examples disclosed herein may help to preserve white portions in compressed images, for example by retaining white colour in images, and/or reducing the amount of blurred edges, or non-white pixels in regions intended to be white, compared with other compression methods. Examples disclosed herein may allow for images to be printed using white ink (instead of leaving blank spaces where the image is white) by improving preservation of white colour in images.

Certain examples disclosed herein may provide a minimum of 2:1 compression, and in some examples may, in practice with real image, achieve ratios of over 12:1.

Throughout this disclosure, the terms “colour levels” and “levels” may be used interchangeably.

A cell may be considered to be a grid of pixels which may be processed as a unit, such as a 4×4 pixel grid. Certain examples disclosed herein may be considered to extend compression formats based on two colours per cell, to supporting up to four colours per cell.

Preserving white background pixels may improve printing applications to yield sharper, more accurate, or better defined edges of objects and to avoid tainting the background. Extending the number of contone levels per cell to up to four as in examples disclosed herein may make a significant improvement in image quality compared with methods using fewer contone levels (e.g. two levels per cell), especially in images including anti-aliased text and/or lines. Contone refers to an image having continuous range of tones, for example from white to black, rather than an approximation of continuous tones such as may be achieved using stippling.

Examples disclosed herein perform fixed length compression (which may be lossy, although if there are below a predetermined number of colours then compression at this stage may be lossless). Fixed length compression may be followed by variable length lossless coding in some examples.

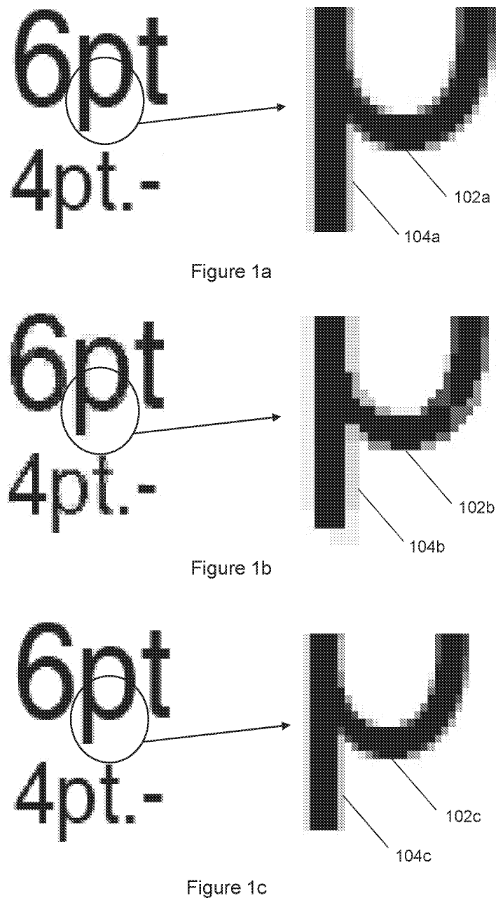

FIGS. 1a-1c show examples of resulting image quality for different examples of compression methods used to an image of anti-aliased text reciting “6 pt 4 pt.-” in black on a white background. For each of FIGS. 1a-1c, a portion of the image is enlarged to show the quality of the image at the edge between black text and white background. FIG. 1a shows the original text/image before compression, FIG. 1b shows the image compressed using a two-colour level lossy compression method, and FIG. 1c shows the image compressed using methods disclosed herein using a four-colour/contone level per cell compression scheme (in this example, four grey levels per cell). It may be seen that the image quality using the present disclosed method is higher than that achieved using a two-colour per cell compression technique. The sharpness of the edge of the text in the original image 102a is comparable with that of the edge of text in the image compressed using methods disclosed herein 102c using a four-colour/contone level per cell compression scheme. The edge of the text 102b in the image of FIG. 1b, compressed using a two-colour level lossy compression method, is less well defined and more jagged/blocky. The amount of intermediate grey pixels between the black text and white background in the original image 104a is comparable with that of the level of intermediate grey at the edge of the text in the image compressed using methods disclosed herein 104c using a four-colour/contone level per cell compression scheme. The amount of intermediate grey pixels 104b in the image of FIG. 1b is larger and covers more of the background which should be white. This leads to a less sharp, more jagged-edged image overall.

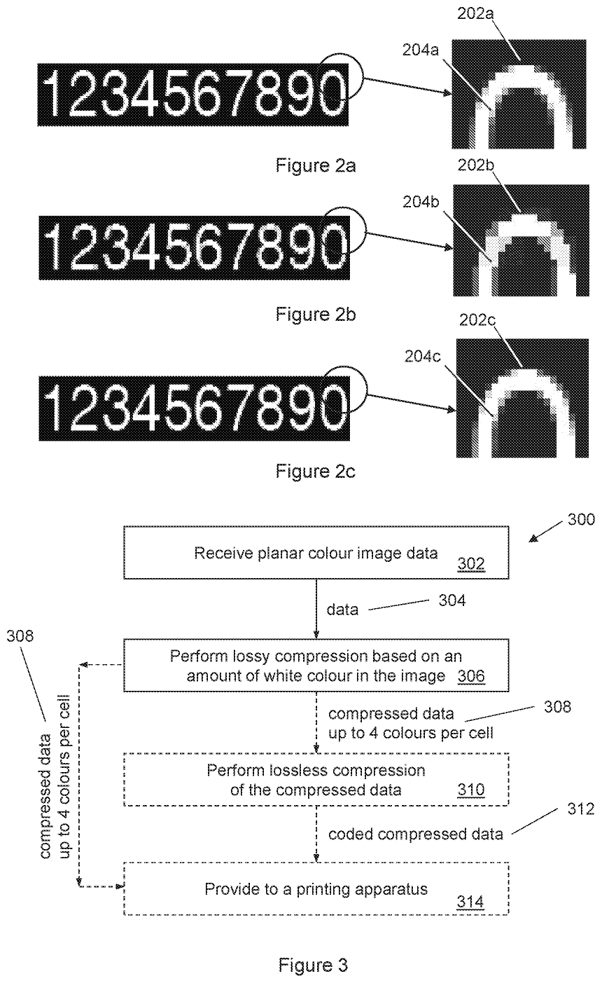

FIGS. 2a-2c show examples of resulting image quality for different examples of compression methods used to an image of anti-aliased reversed text reciting “1234567890” in white on a black background. FIG. 2a shows the original text/image before compression, FIG. 2b shows the image compressed using a two-colour level lossy compression method, and FIG. 2c shows the image compressed using methods disclosed herein using a four-colour/contone level per cell compression scheme (in this example, four grey levels per cell). It may be seen that the image quality using the present disclosed method is higher than that achieved using a two-colour per cell compression technique. The sharpness of the edge of the text in the original image 202a is comparable with that of the edge of text in the image compressed using methods disclosed herein 202c using a four-colour/contone level per cell compression scheme. The edge of the text 202b in the image of FIG. 2b, compressed using a two-colour level lossy compression method, is less well defined and more jagged/blocky. The amount of intermediate grey pixels between the white text and black background in the original image 204a is comparable with that of the level of intermediate grey at the edge of the text in the image compressed using methods disclosed herein 204c using a four-colour/contone level per cell compression scheme. The amount of intermediate grey pixels 204b in the image of FIG. 2b is larger and covers more of the text which should be white. This leads to a less sharp, more jagged-edged image overall.

FIG. 3 illustrates an example method 300 in which data representing a planar colour image is received 302. The received data 304 is then compressed using lossy compression 306 to obtain compressed data 308 The compression is performed based on an amount of white colour of the cell. Each cell of the compressed data 308 may comprise four or fewer colour levels. In some examples, an amount of white colour of the received data (e,g. a number of pixels in each cell of the data) above a predetermined threshold is identified, and the method compresses the cell of the data by retaining the white colour of the cell. For example, in a 4×4 pixel cell, if there are one or more white pixels, then white is used as a colour to compress the cell. That is, white pixels may be preserved by assigning one of the colours of one or more cells of the image data to be white. This may help retention of the white colour in the compressed cell, for example improving image quality of images printed in white ink (e.g. on a non-white background).

In some examples, the compressed data 308 may then be losslessly coded 310 to obtain coded compressed data 312 representing the received planar colour image. The compressed data 308 (or coded compressed data 312 in examples using lossless coding 310) may be provided to a printing apparatus 314 to print the planar colour image using the (coded) compressed data 308, 312, In other examples, the (coded) compressed data 308, 312 may be provided to a display apparatus, such as a colour screen, to display the planar colour image using the (coded) compressed data 308, 312.

The data representing the planar colour image may comprise a plurality of cells. A cell may be a 4×4 pixel cell. Compressing the data 304 using lossy compression 306 may comprise fixed rate compression. Losslessly coding the compressed data 310 to obtain coded compressed data 312 may comprise variable rate compression. Such methods may be performed by an image processor.

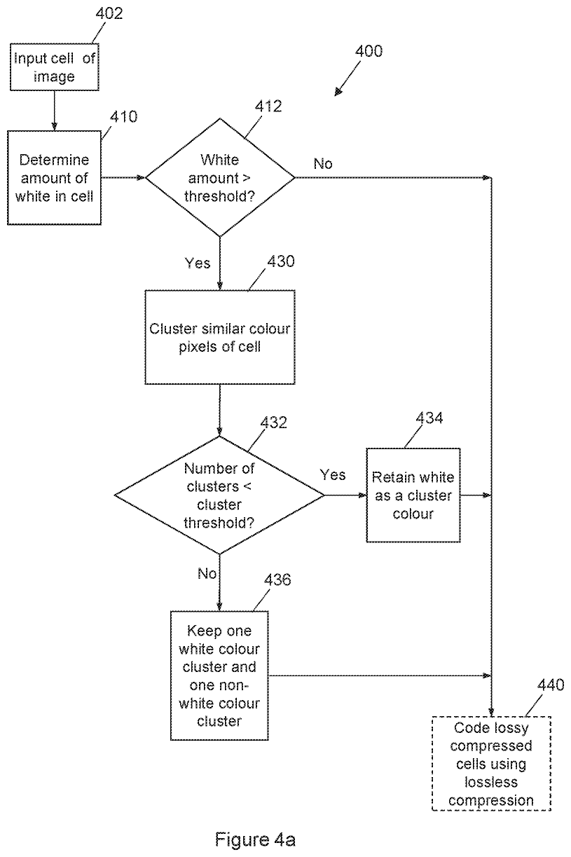

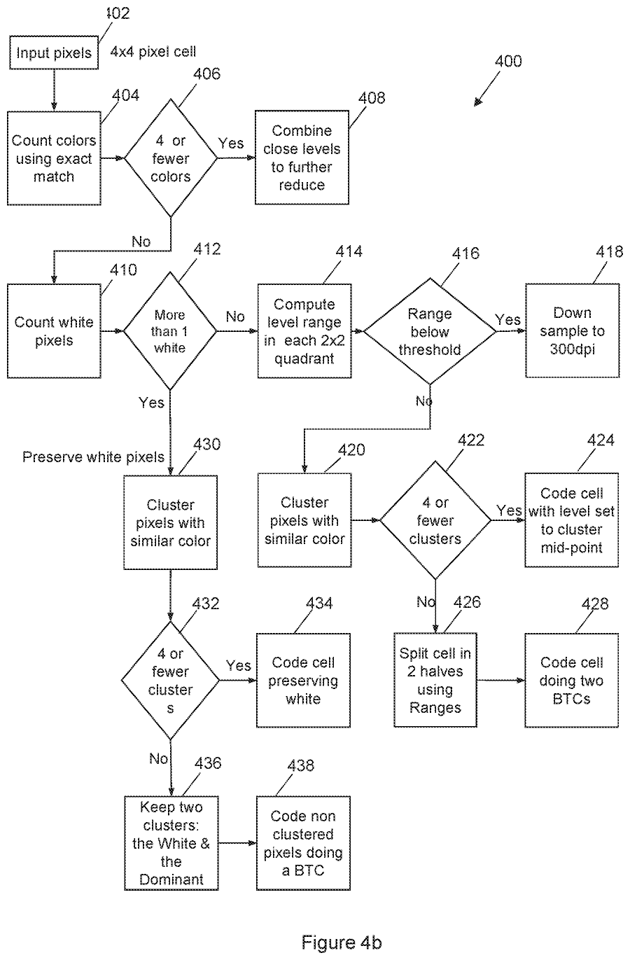

FIGS. 4a and 4b illustrate examples of a workflow 400 to perform fixed-length cell compression, corresponding to the feature of performing lossy compression 306 in FIG. 3. This stage in processing may be considered to serve as an intermediate stage between the original raster data and the final compressed stream (and vice versa). For a 4×4 pixel cell of an image, each 4×4 pixel cell may be truncated into four or fewer contone levels. Then, the cell may be described by those levels and a mask. The mask may have two 2 bits for each of the 4×4 pixels indicating which of four possible grey levels that pixel is mapped to. This format may be supported by a hardware implementation, for example an ASIC or FPGA. The resulting compressed cell may be read directly by the hardware, e.g. FPGA, as the stage of the image pipeline. By using a fixed length compression, it is straightforward to identify a particular cell of the image, for example by a coordinate scheme, allowing for easy computational handling of particular regions of the image.

Identifying an appropriate technique to reduce each pixel cell (e.g. reduce a 4×4 pixel cell having up to 16 different grey levels) down to the four or fewer levels used in examples disclosed herein, while preserving good image quality and also preserving white pixels with a reasonable amount of computation, may be achieved using the example schemes of FIGS. 4a and 4b.

In the example of FIG. 4a, a cell of an image is provided as input 402 to the algorithm 400. The amount of white in the cell is determined 410. If the amount of white is below a predetermined threshold 412, the cell undergoes lossy compression (for example, as illustrated in FIG. 4b) and the lossy compressed cell may be provided for further lossless coding 440. If there is an amount of white in the cell above the threshold 412, the cell is processed to cluster pixels of similar colour together 430. The number of clusters is then determined 432. If the number of clusters is below a cluster threshold value, the cell is encoded to retain white as a colour of the cell 434 and the cell may be provided for further lossless compression 440. Pixels that are nearly white (e.g. within a predetermined number of contone levels away from white) may be included in the white cluster. If more clusters are present than the cluster threshold value, one white cluster is retained and one non-white cluster is retained 436 (and the non-white cluster may be processed further). The clustered cell may then be provided for further lossless compression 440. That is, generally, if an amount of white colour above a predetermined threshold is identified, the image processor is to perform fixed length format cell compression by retaining the white colour of the cell.

The scheme of FIG. 4b is a more detailed example of the fixed length compression process, and includes possible fixed length compression techniques, including:
a. Lossless coding (if the cell has four or fewer distinct colours it may be coded with the exact colours);
b. Interpolation (for example, in which pixels of an e.g. 4×4 cell are downsampled by a factor of two in both directions, with each 2×2 pixel quadrant reduced to one level. Interpolation may be used effectively for cells with gradual changes, such as in natural images.
c. Clustering (pixels of similar grey levels may be clustered together using a single pass algorithm. A cluster may be defined as a range of levels within a maximum distance/range of colour level separation).
d. Two-level Block Truncation Coding (BTC) (the cell may be split into two halves, either top/bottom or left/right, based on the ranges of the pixels in the cell. Each half cell may then be reduced to two levels using a BTC technique that classifies the pixels into two buckets based on their luminance)

In the example of FIG. 4b, an original 4×4 pixel cell is compressed. The pixels are input 402 to the algorithm 400. The number of different colour levels in the cell are counted 404, for example using an exact match method. If four or fewer distinct levels are found 406, the cell is lossless encoded, for example into a four colour format 408, using the exact colours as the input pixels. Otherwise, lossy compression is used to compress the cell in a fixed length format. In other words, fixed length format cell compression of an initial cell of planar image data may comprise lossless coding if the cell has four or fewer colour levels; and lossy compression if the cell has more than four colour levels.

To further improve compression, similar levels that are separated by a predetermined distance threshold may be averaged together. Thus, the number of colours used to encode the data cell may be reduced.

Stepping through the example flow of FIG. 4b, after determining that there are more than four colours in the input cell 406, lossy compression may be used, comprising one or more of; interpolation to downsample the pixels of the cell; clustering to group pixels having colour levels within a colour level similarity range; and block truncation coding to split the cell into two cell portions and reduce the number of colour levels of each cell portion based on pixel luminance.

In the example of FIG. 4b, if more than four colours are found, then the method checks for the presence (e.g. and number) of white pixels 410. In this example, fixed length format cell compression is based on the number of white pixels in the cell, More generally the fixed length format cell compression may be based on the amount of white colour in the cell.

If no white pixels are found all pixels are treated as described below. If one white pixel is found, the white pixel is treated in the same way as any other colour/non-white pixel as described below.

If no white pixels, or one white pixel, is identified, then the method proceeds by computing a colour range 414 (i.e. a difference between the lightest and darkest pixels) of a plurality of sections of the cell, such as each 2×2 pixel quadrant of the 4×4 input cell. If the ranges of the four quadrants are below a low contrast threshold 416 (e.g. 12), the cell is reduced using interpolation 418, to reduce it to four colour levels by downsampling it. For example, a 600 dpi original cell may be downsampled to 300 dpi. This may be achieved by averaging the grey level of the four pixels in each 2×2 quadrant to an average single grey level. Further colour reduction may be applied if the ranges of the individual quadrants are also close to each other, for example when the similar colours are closer than a predefined distance from each other.

If any of the four quadrant ranges have a difference between lightest and darkest pixels beyond the low contrast threshold, then colour clustering is applied 420. Clustering acts to group those pixels with similar levels, even if they are not adjacent to each other within the cell. The number of clusters is determined 422. If four or fewer clusters are obtained then the cell is encoded 424 with the level of each cluster set to the colour level mid-point of the clusters. If more than four clusters are needed, then the cell is split in two halves 426, either top/bottom or left/right, using the ranges computed for each quadrant. Then the cell is split to obtain two 2×4 pixel blocks that have the smallest colour range. Each half cell is then reduced to two colours using Block Truncation Coding (BTC) 428.

In case it is determined during a check of white pixels 412 that there are two or more white pixels in the cell, the method aims to preserve white pixels. For example, for a 4×4 pixel cell, if two or more pixels are white, white may be used as a colour to code the cell. More generally, the amount of white (e.g. number of white pixels) in the cell may be determined; and if the amount of white (e.g. number of white pixels) in the cell exceeds a predetermined threshold (e.g. exceeding one pixel of white pixels per cell), white may be used as a colour in the compressed cell.

The example algorithm illustrated in FIG. 4b proceeds, on determining that more than one pixel in the cell is white, with the colour clustering technique 430 explained above, with the difference that white is used as the colour to define the first cluster. Pixels that are nearly white may join the white cluster. The number of clusters is determined 432. If four or fewer clusters are obtained, the cell is encoded 434 using pure white for the white cluster and by calculating the mid-point for the other clusters. If more than four clusters are obtained, then two clusters get preserved 436 (the white cluster and the dominant cluster having the most pixels of the clusters). The remaining pixels are reduced to two colours using the BTC technique 438. Once the fixed length compression is performed on a cell, the compressed cell may be provided for coding to obtain a coded compressed cell.

To obtain further compression during fixed length compression, colour levels which are closer than a programmable distance and which are not white may be merged together.

Following fixed length compression (lossless or lossy) compression, the compressed cell may then be coded using variable length compression coding 440, for example lossless coding of variable cell length. Using a variable length coding scheme may allow for efficient coding of the compressed cells. Variable length lossless coding may be used to code the compressed cell resulting from fixed length compression to occupy between one and nine bytes as a coded compressed cell.

There are different ways in which compressed cells may be coded, which may be based on the method of lossy (or lossless) fixed length compression used. Overall, in some examples, each cell may be coded to occupy between one and nine bytes.

A cell may be coded to define the format of the cell, a description of the cell mask, and the grey colour levels of the cell. In other words, a coded compressed cell may comprise one or more of; a format portion indicating a format of the cell; a mask portion indicating a mask of the cell based on the number of colour levels of the cell; and a colour level portion indicating the grey levels of the cell.

The first byte used to code the compressed cell may describe the format of the cell, and may define:
a. the number of different colour levels the cell contains (1, 2, 3 or 4);
b. the type of those levels, with the options being: Transparent (T), White (W), Black (B) or Grey (G); and
c. the format and compression mode of the mask of the cell.

In other words, the format portion of the coded compressed cell may indicate a type of fixed length format cell compression used to obtain the compressed cell from the cell. This format portion of the coded compressed cell may be indicated by the first byte of the coded compressed cell.

A mask description may follow a cell format code byte. The mask description may take two bytes if the cell has two colours, and four bytes if the cell has three or four colours. That is, a number of bytes of the coded compressed cell which are occupied by the mask portion may be based on the number of colour levels of the cell.

After the mask description, the actual levels of the grey colours may follow. In some examples, Transparent, White and Black colours do not need any additional data because their values are well known and the code byte describes if they are present in the cell and which sequence they follow as explained below That is, the colour level portion of the coded compressed cell may indicate one or more of: a sequence of colour types in the cell selected from Transparent, White, Black and one or more Greys; grey colour levels of the cell; and a number of colour levels in the cell.

Examples of code byte values now follows in which the code byte represents, at least in part, the type of fixed length compression performed on the cell.

A single colour cell may be coded with one single byte. An original 8-bit contone level may thus be reduced to 7-bits. In hexadecimal the single colour cell may be coded as a value between 0x00 to 0x7F (in binary this is a value between 00000000 to 01111111 (i.e. 0 [7 bits describing the colour level], and in decimal this is a value between 0 to 127).

A two, three, or four colour cell may be coded using between three and nine bytes. In hexadecimal the cell may be coded as a value between 0x80 to 0x9F (in binary this is represented as 100[3 bits representing the colour sequence][2 bits representing the number of colours of the cell], i.e. 10000000 to 10011111, and in decimal this is a value between 128 to 159).

The [2 bits representing the number of colours of the cell] may be coded as “the number of colours in the cell minus two”, so that a value of 0 represents two colours, a value of 1 represents three colours, a value of 2 represents four colours, and a value of 4 represents four colours and a compressed mask.

The mask byte values may follow the code byte value. The mask bytes may take two bytes if the cell has two colours, and take four bytes for three or four colours. If the lower two bits=3 then the mask may be 300 dpi and takes one byte (i.e. 2 bits per 2×2 pixel quadrant) for a 4×4 pixel cell. In this way, the mask may be compressed (e.g. reduced, optimized).

The [three bits representing the colour sequence] may indicate the sequence of possible type of colours from Transparent (T), White (W), Black (B), and Grey (G). Since Transparent, White and Black are single value colours (i.e. they are single value pure colours, unlike Grey which may take different values depending on the shade of Grey) and can appear once in a cell, the following eight sequences of colours are possible for use in describing all possible combinations.

| | | |
|---|---|---|
| code: | 0 | TWBG |
| code: | 1 | TWGG |
| code: | 2 | TBGG |
| code: | 3 | TGGG |
| code: | 4 | WBGG |
| code: | 5 | WGGG |
| code: | 6 | BGGG |
| code: | 7 | GGGG |

The order of the colours as “TWBG”, i.e. the first pixel is transparent, the next is white, the next is black, and the fourth pixel is grey, is a predetermined order. By defining the colours in this order, all possible sequences of colours are reduced to eight and use three bits in the code byte.

The next bytes may be the grey colours (Transparent, White or Black are implicit in the cell code and not encoded in the stream).

A two colour cell with common/predefined edge mask may be coded with three bytes. In hexadecimal the cell may be coded as a value between 0xA0-0xDF (in binary this is represented as 10100000 to 11011111, and in decimal this is a value between 160 to 223).

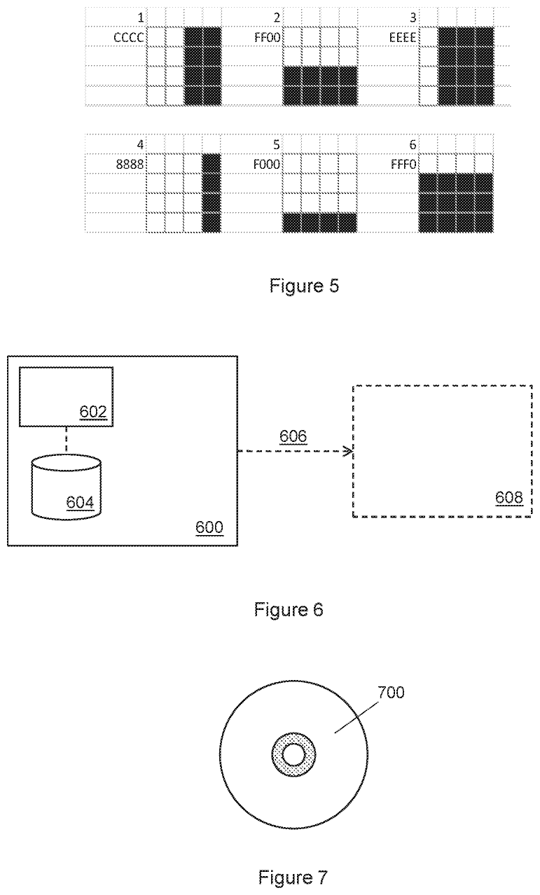

Thus, for a cell having exactly two colours, a 16 bit mask (one bit/pixel for two colours) may be one of 64 possible predefined combinations. The next two bytes are the colours of the two colour cell, and may be explicitly coded in the stream (as Transparent, White, Black or Grey). There may be, for example, 64 predefined masks, which may be selected as most common masks that appear compressing complex images. In other examples, a different number or different selection of predefined masks may be used dependent on the image. An example of six popular masks are shown in FIG. 5 alongside their hexadecimal two byte codes (CCCC, FF00, EEEE, 8888, F000 and FFF0). In an example using 64 predefined masks, the top left pixel of the cell may use the first of the two colours (shown in white in FIG. 5).

When encoding, if the top left pixel of the actual cell mask has a value of 1, then the mask may be inverted and the order of the colours may therefore be swapped, extending the effective pre-defined masks to 128 for a 64 predefined mask system.

Thus, in some examples, the mask portion indicating the mask of the cell may be compressed to occupy one byte if the cell has three or four colours, and each quadrant of the cell has a same mask value, wherein a mask of each of the cell quadrants occupies a respective two bits of the one byte. In other words, for three or four colour 4×4 pixel cells, the mask may be compressed from four bytes to one single byte when the four pixels on each sub quadrant (e.g, a 300 dpi subcell) share the same mask value. Then the mask byte occupies two bits for each of the four quadrants.

In some examples, if the cell has two colours, one of 64 predefined masks may be selected as the mask of the cell and the cell may be compressed to occupy three bytes, wherein the format portion occupies one byte and defines the cell as a two colour cell and which of the 64 predefined masks is the mask of the cell, and the two colours of the cell occupy one byte each, as exemplified by masks shown in FIG. 5. That is, for two colour cells there may be 64 pre-defined masks for the most common cases. In this example, the cell-code byte may define a two-colour cell and define which of the 64 pre-defined masks to use. Thus, the cell takes three bytes; one code byte and two colour bytes.

The mask may take the same amount of space in Chunky (i.e. RGB) format as in planar format, because the space requirements depend on the number of colours in the cell. A difference is that, in a planar format, each plane is compressed separately. Therefore, there may be one mask per plane, thus mask compression may help to reduce computation and storage resource requirements.

A downsampled four colour cell with a 300 dpi mask may be coded with five bytes. In hexadecimal the cell may be coded as 0xE0 (in binary this is represented as 11100000, and in decimal this is a value of 224. This cell code implicitly defines the two bit/pixel mask for four colour cells as 0xFAFA5050, which is the mask resulting from downsampling the cell from 600 dpi to 300 dpi, without needing to use four bytes to code 0xFAFA5050. Four bytes follow the code, defining the four grey levels. In other words, if the compressed cell is compressed using interpolation to downsample the pixels of the cell, the coded compressed cell may occupy five bytes, wherein one byte defines the coded compressed cell as a downsampled cell, and four bytes define four grey levels of the cell. This type of cell may be offered a dedicated cell code (e,g. here of 0xE0) because they appear often compared to other cell types.

A run length 8-bit contone cell may be coded with two bytes for up to nine cells. This coding may be used to code identical colour cells in a computationally efficient way. In hexadecimal the cell may be coded as a value between 0xE8-0xEF (in binary this is represented as 11101000 to 11101111, and in decimal this is a value between 232 to 239. This coding may be used for single colour areas of more than one cell. The lower three bits of the code may specify the run-length (number of exact colour cells) with code 0xE8=to two identical cells up to code 0xEF=to nine identical cells. The next byte may specify the exact 256 grey level of the contone.

In some examples such as those described above, no chunky compression may be used. In some examples, the coding of the image cells may be performed in the same way, such as described above, regardless of the nature of the image (e.g. photographic, textual).

FIG. 6 shows an example of an apparatus 600 according to examples disclosed herein. The apparatus 600 of FIG. 6 comprises a processor 602 which is to perform fixed length format cell compression on a cell of a planar colour image based on an amount of white colour of the cell, the cell comprising a plurality of pixels, to obtain a compressed cell having four or fewer colour levels. The processor may in some examples perform variable length format cell compression on the compressed cell to obtain a coded compressed cell. The apparatus 600 may be, or comprise, an image processor. In some examples, such an image processor may be an apparatus 600 comprising a processor 602, a computer readable storage 604 coupled to the processor 602, and an instruction set to cooperate with the processor 602 and the computer readable storage 604 to perform the functions described. The processor may provide the compressed cell image data (or, if coded using variable length coding, provide coded compressed cell image data) to a printing apparatus for printing a hard copy of the image, and/or may provide the (coded) compressed cell image data to a display apparatus, such as an LCD screen, for electronic display.

In some examples, such an image processor may be implemented as hardware, for example as an application-specific integrated circuit (ASIC) or field-programmable gate array (FPGA)].

In some examples the apparatus to carry out a method as described herein may be a suitable programmed processor 602. In some examples the apparatus may comprise such a processor 602 and may be, or comprise, one or more of an image processor; a printer driver; a raster image processor of a printing system; a printer; and an image capture device. In some examples, the (coded) compressed cell is to, when processed for printing by a printing apparatus, provide an output planar colour image cell corresponding to the cell of the planar colour image. For example, the (coded) compressed cell may be transmitted to a printing apparatus for printing the initial planar colour image.

FIG. 7 illustrates computer readable storage 700. Disclosed herein is an apparatus (e.g. the apparatus 600 of FIG. 6 performing the method 300 shown in FIG. 3), wherein the apparatus comprises a processor and a computer readable storage 700 coupled to the processor; and an instruction set to cooperate with the processor and the computer readable storage 700. The instruction set may cause the apparatus to perform, or cause a suitable device coupled thereto to perform, any method described herein. In other examples, the apparatus 600 of FIG. 6 may perform any other method disclosed herein.

FIG. 7 may be considered to show a computer readable storage medium having executable instructions stored thereon which, when executed by a processor, cause the processor to perform any method disclosed herein. The machine readable storage 700 can be realised using any type or volatile or non-volatile (non-transitory) storage such as, for example, memory, a ROM, RAM, EEPROM, optical storage and the like.

In some examples, a non-transitory computer readable storage medium may have executable instructions stored thereon which, when executed by a processor, cause the processor to compress planar colour image data comprising a plurality of cells, based on an amount of white colour of the cell, to obtain compressed planar colour image data cells, wherein each compressed planar colour image data cell includes four or fewer colours. In some examples the executable instructions may, when executed by a processor, cause the processor to code each compressed planar colour image data cell to obtain a plurality of coded compressed planar colour image data cells.

Procedures and apparatus disclosed herein may provide a compression ratio between an initial input cell and an output coded compressed cell of at least 2:1. In some examples, the compression ratio may be better than 12:1. Examples may provide efficient image compression while preserving white pixels and yielding good image quality, with a practically manageable amount of computation. An improved balance may be provided between reducing computational overheads and improving final image quality.

In some examples, artefacts may be reduced or eliminated when printing text, in particular small text (e.g, smaller than 10 pt) especially white text over a dark background. Examples disclosed may provide improved image compression for planar image data, which may be used in CMYK workflows or with extended colours and spot colours. It may improve the preservation of white pixels, and may improve final print quality compared to other methods. Examples disclosed herein which maintain white pixels may readily be amended to preserve black pixels instead, Some examples of output image may be visually lossless, even with anti-aliased text and lines.

Throughout the description and claims of this specification, the words “comprise” and “contain” and variations of them mean “including but not limited to”, and they are not intended to (and do not) exclude other components, integers or elements. Throughout the description and claims of this specification, the singular encompasses the plural unless the context suggests otherwise. In particular, where the indefinite article is used, the specification is to be understood as contemplating plurality as well as singularity, unless the context suggests otherwise.

1. An image processor to:
perform fixed length format cell compression on a cell of a planar colour image based on an amount of white colour of the cell, the cell comprising a plurality of pixels, to obtain a compressed cell having four or fewer colour levels.

2. The image processor of claim 1, wherein, if an amount of white colour of the cell above a predetermined threshold is identified, the image processor is to perform fixed length format cell compression by retaining the white colour of the cell.

3. The image processor of claim 1, wherein the instruction set is to cooperate with the processor and the computer readable storage to:
determine the number of white pixels in the cell; and
if the number of white pixels in the cell exceeds a predetermined threshold of white pixels per cell, use white as a colour in the compressed cell.

4. The image processor of claim 1, wherein the fixed length format cell compression comprises one or more of:
interpolation to downsample the pixels of the cell;
clustering to group pixels having colour levels within a colour level similarity range; and
block truncation coding to split the cell into two cell portions and reduce the number of colour levels of each cell portion based on pixel luminance.

5. The image processor of claim 4, wherein the fixed length format compression comprises clustering, and wherein:
when the number of clusters is below a predetermined cluster threshold, one of the clusters is white; and
when the number of clusters is above the predetermined cluster threshold, two clusters are retained, wherein one of the two retained clusters is white.

6. The image processor of claim 1, further to:
perform variable length format cell compression on the compressed cell to obtain a coded compressed cell.

7. The image processor of claim 6 wherein the coded compressed cell comprises one or more of:
a format portion indicating a format of the cell;
a mask portion indicating a mask of the cell based on the number of colour levels of the cell; and
a colour level portion indicating the grey levels of the cell.

8. The image processor of claim 7, wherein the format portion of the coded compressed cell indicates a type of fixed length format cell compression used to obtain the compressed cell from the cell.

9. The image processor of claim 8, wherein a number of bytes occupied by the mask portion is based on the number of colour levels of the cell.

10. The image processor of claim 7, wherein the colour level portion of the coded compressed cell indicates one or more of:
a sequence of colour types in the cell selected from Transparent, White, Black and one or more Greys;
grey colour levels of the cell; and
a number of colour levels in the cell.

11. The image processor of claim 7, wherein the mask portion indicates the mask of the cell has been compressed by one or more of:
if the cell has three or four colours, and each quadrant of the cell has a same mask value, the mask of the cell is compressed to occupy one byte, wherein a mask of each of the cell quadrants occupies a respective two bits of the one byte; and
if the cell has two colours, one of 64 predefined masks is selected as the mask of the cell and the cell is compressed to occupy three bytes, wherein:
the format portion occupies one byte and defines the cell as a two colour cell and which of the 64 predefined masks is the mask of the cell, and
the two colours of the cell occupy one byte each.

12. The image processor of claim 6, wherein, when the compressed cell is compressed using interpolation to downsample the pixels of the cell, the coded compressed cell occupies five bytes, wherein:
one byte defines the coded compressed cell as a downsampled cell; and
four bytes define four grey levels of the cell.

13. The image processor of claim 1, wherein the image processor is comprised as a part of:
a printer driver;
a raster image processor of a printing system;
a printer; and
an image capture device.

14. A method comprising:
receiving data representing a planar colour image;
compressing the data using lossy compression to obtain compressed data based on an amount of white colour of the cell, wherein each pixel of the compressed data comprises four or fewer colour levels; and
providing the compressed data to one or more of: a printing apparatus to print the planar colour image using the coded compressed data; and a display apparatus to display the planar colour image using the coded compressed data.

15. A non-transitory computer readable storage medium having executable instructions stored thereon which, when executed by a processor; cause the processor to:
compress planar colour image data comprising a plurality of cells to obtain compressed planar colour image data cells, based on an amount of white colour of the cell, wherein each compressed planar colour image data cell includes four or fewer colours.
